(19) United States
(12) Patent Application Publication
(10) Pub. No.: US 2007/0166425 A1
(43) Pub. Date: Jul. 19, 2007

(54) Optical Element Molding Device

(76) Inventor: Masanori UTSUGI, Ageo City (JP)

Correspondence Address: ARNOLD INTERNATIONAL, P. O. BOX 129, GREAT FALLS, VA, 22066-0129, US

(21) Appl. No.: 11/621,278

(22) Filed: Jan. 9, 2007

(30) Foreign Application Priority Data
Jan. 17, 2006 (JP) 2006-008802

(51) Int. Cl. B29C 43/00; B29C 43/52; B29C 35/02

(52) U.S. Cl. 425/408; 425/808

(57) ABSTRACT

An optical element molding device includes upper and lower mold elements and first and second cavity mold elements. Each of the upper and lower mold elements includes a pedestal and a shaft projecting along a common axis from a flange surface of each pedestal. An optical function transferring surface is formed at the tip of each shaft with the tips facing one another along the common axis. The first cavity mold element extends around these tips and the common axis for molding an optical element by heating and pressuring an optical material arranged between the upper and lower mold elements by their relative movement toward one another along the common axis guided by the first cavity mold element. Various surfaces contact one another in order to limit relative movement of the upper and lower mold elements along the common axis during molding and constrain axial inclination of these mold elements.

### FIELD OF THE INVENTION

The present invention relates to an optical element molding device and particularly relates to an optical element molding device that enables molding an optical element with high accuracy.

### BACKGROUND OF THE INVENTION

Associated with recent steps toward miniaturization, light weight, and providing multiple functions in optical apparatuses, various optical elements for use in optical systems have been developed. In particular, in products that use a lens with an optical disc, including pickup lenses used in optical instruments, such as DVDs (digital versatile disks), higher accuracy and higher numerical apertures of the optical elements are in demand. In addition, in Blu-ray Discs (large capacity phase change discs), in order to realize high density data memories, lenses with high numerical apertures are used along with a blue violet laser having a short wavelength, and it is anticipated that the demand for optical elements with higher numerical apertures will increase in the future.

In general, optical elements are required that provide an optical function where a light beam irradiated from one point on a plane that is perpendicular to the optical axis transmits through the optical elements and converges onto a focal point on a plane that is perpendicular to the optical axis. However, because of molding errors on the optically functional surfaces of the optical elements, a beam irradiated from one point does not completely converge after transmission through the optical elements, and deviations resulting in aberrations occur. Therefore, in a lens for an optical disc requiring higher accuracy and a higher numerical aperture, it is necessary to reduce molding errors on the optically functional surfaces and to remove aberrations from the products as much as possible.

Conventionally, with the aim of molding optical elements with higher accuracy, various optical element molding devices for manufacturing optical elements have been developed that satisfy optically required performance by arranging preformed optical materials in predetermined molds and heating and pressuring the optical material within the molding device.

However, conventional optical element molding devices generally mold optical elements by interposing upper and lower mold elements inside one or more cavity molds and by heating and pressuring optical materials. In these molding devices, a minimum clearance is required between the upper and lower mold elements and the cavity mold element or elements, so the structures easily induce deviations on the optically functional surfaces molded by the upper and lower mold elements. As factors inducing molding errors on the optically functional surfaces, deviation of axes and inclination of the axes in the upper and lower mold elements at the time of molding optical elements are known. In particular, the axial inclination of the upper and lower mold elements greatly affects the aberrations of the molded optical elements.

Consequently, for the purpose of controlling the axial inclination in the upper and lower mold elements introduced by the clearance between the upper and lower mold elements and the cavity mold element or elements, for example, in Japanese Laid-Open Patent Application No. Hei 6-256025, in order to contrain twisting or optical axis deviation in the upper and lower mold elements from being introduced by a molding error of the upper and lower mold elements and the cavity mold element or elements, a construction of a molding device is disclosed having a first cavity mold element that is slidable and accommodates the upper mold element and a second cavity mold element where the lower mold element is pressured and secured to the first cavity mold element on the same axis as the optical axis of the upper mold element and contains the upper and lower mold elements and the first cavity mold element.

In the conventional molding device described in Japanese Laid-Open Patent Application No. Hei 6-256025 discussed above, because the thicknesses of molded lenses are specified by having upper and lower heating plates that heat and press the upper and lower mold elements while coming into contact with the second cavity mold element, the processing accuracy of the contact surface with the second cavity mold element on the upper and lower heating plates greatly affects the molding accuracy of the molded lens due to the axial inclination in the upper and lower mold elements. In other words, even for the processing accuracy of the contact surface with the upper and lower heating plates in the second cavity mold element, if the processing accuracy of the contact surface with the second cavity mold element in the upper and lower heating plates cannot be sufficiently obtained, aberrations of the molded lens will be induced by the axial inclination of the upper and lower mold elements.

Therefore, even though processing of the contact surfaces of the upper and lower heating plates with the second cavity mold element is required with high accuracy, because the device itself with the upper and lower heating plates has a large configuration, it is difficult to process the device itself with high accuracy. Moreover, even if the contact surfaces are processed with high accuracy, maintenance is required because the surface accuracy of the contact surfaces decreases due to abrasion or damage during the repetition of the lens molding process. However, when maintaining the upper and lower heating plates, it is necessary to disassemble them from the molding device so that reprocessing the surfaces and reassembling the elements leads to the maintenance process itself becoming complex.

### BRIEF SUMMARY OF THE INVENTION

The present invention relates to an optical element molding device that enables molding optical elements by constraining the deviation and inclination of the axes in upper and lower mold elements according to a simple structure that works excellently and that has excellent maintenance properties.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 shows an exploded cross-sectional view of the optical element molding device of Embodiment 1 of the present invention; FIGS. 2A-2B show cross-sectional views of the optical element molding device of FIG. 1 before and during molding heating and pressure being applied, respectively;

FIG. 3 shows a cross-sectional view of the optical element molding device of Embodiment 2 of the present invention;

FIG. 4 shows a cross-sectional view of a modification of the optical element molding device of Embodiment 2 of the present invention;

FIG. 5 shows a cross-sectional view of the optical element molding device of Embodiment 3 of the present invention; and

FIGS. 6A-6B show cross-sections of arrangements of mold elements with errors of axial alignment and axial inclination, respectively, that result in errors in the shape of the optical function surfaces of molded optical elements.

### DETAILED DESCRIPTION OF THE INVENTION

A general description of the optical element molding device of the present invention that pertains to disclosed embodiments of the invention will now be given. An optical element molding device according to the present invention includes an upper mold element, a lower mold element, a first cavity mold element, and a second cavity mold element that includes an upper end surface and a lower end surface. Each of the upper mold element and the lower mold element includes a pedestal and a shaft projecting from each pedestal. The shafts of the pedestals extend along a common axis, and an optical function transferring surface is formed at the tip of each shaft with the tips facing one another along the common axis. The first cavity mold element extends around the tips and the common axis for molding an optical element by heating and pressuring an optical material arranged between the upper mold element and the lower mold element by the upper mold element and the lower mold element moving relatively toward one another along the common axis guided by said first cavity mold element. Each of the pedestals includes a flange surface extending away from the common axis. The second cavity mold element extends around the first cavity mold element but does not contact the first cavity mold element. At least one of the upper end surface and the lower end surface contacts one of the flange surfaces in order to limit relative movement of the upper mold element and the lower mold element toward one another during molding of an optical element and at the same time constrains axial inclination of the upper mold element and the lower mold element about the common axis.

As described above, the upper and lower mold elements operate so that their movements along the common axis direction are guided by the first cavity mold element. When heating and pressuring an optical material, the upper and lower mold elements become closer to each other, and the second cavity mold element comes into contact with at least the flange surface of the upper or lower mold element. This results in limiting the closeness of the upper and lower mold elements and thus the pressure applied, and prevents axial inclination being introduced with excessive pressure. Additionally, because one of the upper end surface and the lower end surface contacts one of the flange surfaces of the upper and lower mold elements and the second cavity mold element contact surface has been processed to secure a sufficient parallelism of the upper and lower mold elements in the contact state, the axial inclination can be more strictly constrained.

In addition, the optical element molding device of the present invention is particularly beneficial when applied to molding aspherical optical elements requiring high processing accuracy.

As described above, the optical element molding device of the present invention constrains deviation and inclination of axes in the upper and lower molds, which enables molding optical elements with high accuracy with a simple structure that works excellently.

Specific embodiments of the optical element molding device of the present invention are described in detail below with reference to the attached drawings. Furthermore, in these descriptions and drawings, any functional components having substantially identical functional configurations are referenced by the same reference symbols and any redundant descriptions are omitted. Additionally, any functional components of an embodiment that differ slightly from, but clearly correspond to, functional components of a previously described embodiment are referenced by the same reference symbol with one or more prime (′) symbols added.

### Embodiment 1

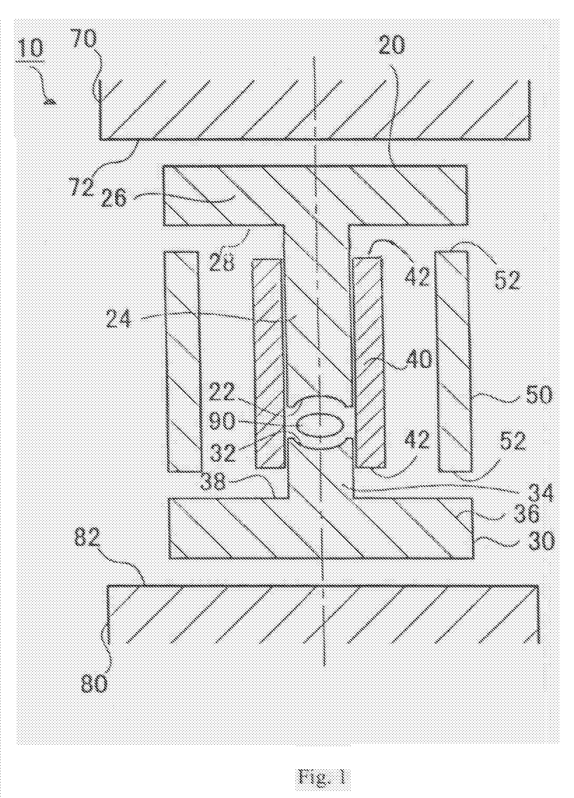

FIG. 1 shows an exploded cross-sectional view of the optical element molding device of Embodiment 1 of the present invention. The molding device 10 shown in FIG. 1 includes a pair of upper and lower mold elements 20 and 30, a first cavity mold element 40, a second cavity mold element 50, and a pair of upper and lower pressuring plates 70 and 80. Hereinafter, characteristics of each component contained in the related optical element molding device 10 are described.

Each of the upper mold element 20 and the lower mold element 30 includes a pedestal, 26 and 36, respectively, and a shaft, 24 and 34, respectively, projecting from each pedestal. The pedestals 26 and 36 each have a transverse section that is larger than those of the shafts 24 and 34, respectively. The upper and lower mold elements 20 and 30 have outer surfaces on the shafts 24 and 34 that are inside the first cavity mold element 40 and adjacent the inner surface of the first cavity mold element 40. Flanges 28 and 38 form outer surfaces of the pedestals 26 and 36, respectively, where the bases of the shafts 24 and 34 and their common axis meet the pedestals 26 and 36 at these outer surfaces formed at right angles to this common axis so that the shafts 24 and 34 are perpendicular to pedestals 26 and 36.

The first cavity mold element 40 has at least roughly the shape of a right circular cylinder with a hollow interior and with its axis extending along the common axis of the shafts 24 and 34 of the upper and lower mold elements 20 and 30. In the embodiments of the present invention described herein, the shafts are assumed to have the same cross-sections in the direction perpendicular to the common axis. A minimum clearance is provided between the inner surface of the hollow interior of the first cavity mold element 40 and the outer surfaces of the shafts 24 and 34 of the upper and lower mold elements 20 and 30 for sliding movement of the upper and lower mold elements 20 and 30 toward and away from each other in the vertical direction, as shown in FIG. 1. The first cavity mold element 40 has an axial length in the direction of the common axis that is smaller than the sum of the axial lengths of the shafts 24 and 34 of the upper and lower mold elements 20 and 30. Here, the axial lengths of the shafts 24 and 34 are substantially equal to the distance between the tip surfaces where optical function transferring surfaces 22 and 32 are located and the flange surfaces 28 and 38 of the pedestals 26 and 36, respectively. Moreover, the first cavity mold element 40 has upper and lower end surfaces 42, 42 that are perpendicular to the axis of the first cavity mold element 40.

The second cavity mold element 50 is arranged around the first cavity mold element 40 so as not to come into contact with the first cavity mold element 40. The second cavity mold element 50 has at least roughly the shape of a right circular cylinder with a hollow interior and with its axis extending generally along the common axis of the shafts 24 and 34 of the upper and lower mold elements 20 and 30. The hollow interior of the second cavity mold element 50 is larger than the hollow interior of the first cavity mold element 40 and has an axial length that is longer than the axial length of the first cavity mold element 40 and also longer than the sum of the axial lengths of the shafts 24 and 34 of the upper and lower mold elements 20 and 30. Additionally, the second cavity mold element 50 also has upper and lower end surfaces 52, 52 perpendicular to its axis, similarly to the first cavity mold element 40.

As shown in FIG. 1, a pair of upper and lower pressuring plates 70 and 80 have pressuring surfaces 72 and 82, which are larger than the outer surfaces of the pedestals 26 and 36 of the upper and lower mold elements 20 and 30, and are arranged opposing each other. The upper and lower mold elements 20 and 30, the first cavity mold element 40 and the second cavity mold element 50 are positioned between the pressuring surfaces 72 and 82, and the upper and lower pressuring plates 70 and 80 themselves are maintained to be movable by pressuring mechanisms (not shown in FIG. 1) suitably arranged at the upper and lower ends. Moreover, the pressuring surfaces 72 and 82 of the upper and lower pressuring plates 70 and 80 are formed as flat surfaces opposing the end surfaces of the pedestals 26 and 36 of the upper and lower mold elements 20 and 30, respectively.

Furthermore, among components that form the molding device 10, the optical function transferring surfaces 22 and 32 of the upper and lower mold elements 20 and 30 are formed, for example, with three to ten millimeters or less of processing accuracy; the end surfaces 42 and 52 of the first and second cavity mold elements 40 and 50 are formed, for example, also with three to ten millimeters or less of processing accuracy; and the pressuring surfaces 72 and 82 of the upper and lower pressuring plates 70 and 80 are formed, for example, with one to ten millimeters or less of processing accuracy.

In the optical element molding device 10, an optical material 90 arranged between the optical function transferring surfaces 22 and 32 formed in the upper mold element 20 and the lower mold element 30, respectively, is heated and pressured, and an optical element to which the shapes of the optical function transferring surfaces have been transferred is molded. Heating and pressuring processes for the optical material 90 using the molding device 10 of Embodiment 1 are described hereinafter with reference to FIGS. 2A-2B.

As shown in FIG. 2A, the lower mold element 30 is placed so as to have the lower surface of its pedestal 36 making contact with the pressuring surface 82 of the lower pressuring plate 80, and the optical material 90 is arranged on the optical function transferring surface 32 formed on the tip surface of the shaft 34. The first cavity mold element 40 is placed so as to have its lower end surface 42 making contact with the flange surface 38 of the lower mold element 30, and to have the outer surface of the shaft 34 of the lower mold element 30 adjacent the inner surface of the first cavity mold element 40. In the same manner, the second cavity mold element 50 is placed so as to have its lower end surface 52 making contact with the flange surface 38 of the lower mold element 30 but so as to not make contact with the first cavity mold element 40. Then, the upper mold element 20 is arranged at the upper side of the lower mold element 30 so as to have the optical function transferring surface 22 formed on the tip surface of the shaft 24 opposing the optical function transferring surface 32 of the lower mold element 30. Here, the upper and lower mold elements 20 and 30 and the first and second cavity mold elements 40 and 50 are arranged along concentric axes.

The upper and lower mold elements 20 and 30 are equipped with a heater (not shown in the drawings), such as a resistance heater, for the purpose of heating and softening the optical material 90 which is arranged between the optical function transferring surfaces 22 and 32. The upper and lower mold elements 20 and 30 are initially heated by heat transferred from the heater; the heated and softened optical material 90 is pressured by the upper and lower mold elements 20 and 30 as shown in FIG. 2B; and the optical element to which the shapes of the optical function transferring surfaces have been transferred is molded.

The upper and lower mold elements 20 and 30 follow the movements of the upper and lower pressuring plates 70 and 80, which move up and down by ascent and descent forces provided from the pressuring mechanisms (not shown in the drawings). The vertical movements of the upper and lower mold elements 20 and 30 are guided by their outer surfaces that slide in a close friction fit against the inner surface of the first cavity mold element 40, thereby restraining an axial deviation. In addition, in the upper and lower mold elements 20 and 30, even if axial inclination occurs during pressing, when the second cavity mold element 50 comes into contact with the upper and lower mold elements 20 and 30, the pressuring limit distance determined by the separation of the upper and lower mold elements 20 and 30, which determines the central thickness of the optical element being molded, is reached and any axial inclination is further constrained.

As described above, it is necessary that the first cavity mold element 40 be formed so as to have its axial length smaller than the total of the axial lengths of the shafts 24 and 34 of the upper and lower mold elements 20 and 30, and, additionally, it is necessary that the second cavity mold element 50 be formed so as to have its axial length larger than that of the first cavity mold element 40, and also larger than the sum of the axial lengths of the shafts 24 and 34 of the upper and lower mold elements 20 and 30. Consequently, the first cavity mold element 40 will not simultaneously come into contact with both the upper and lower mold elements 20 and 30, and the end surfaces of the shafts 34 and 24 of the lower mold element 30 and the upper mold element 20 will never come into contact with each other, but rather the second cavity mold element 50 comes into contact with the lower mold element 30 and the upper mold element 20.

In other words, when the second cavity mold element 50 comes into contact with both of the lower mold element 30 and the upper mold element 20, the lower end surface 52 of the second cavity mold element 50 makes contact with the flange surface 38 of the lower mold element 30 and the upper end surface 52 of the second cavity mold element 50 makes contact with the flange surface 28 of the upper mold element 20. As described above, the upper and lower end surfaces 52, 52 of the second cavity mold element 50 are formed as surfaces that are perpendicular to the axis of the second cavity mold element 50, and the flange surfaces 28 and 38 of the upper and lower mold elements 20 and 30 are formed as surfaces that are perpendicular to the axes of the upper and lower mold elements 20 and 30, respectively. Consequently, the upper and lower end surfaces 52, 52 of the second cavity mold element 50 come into contact with the flange surfaces 28 and 38 of the upper and lower mold elements 20 and 30, respectively, and thus, the upper and lower end surfaces 52, 52 and the flange surfaces 28 and 38 function to constrain the alignment of the tip surfaces of the shafts 24 and 34 of the upper and lower mold elements 20 and 30 where the optical function transferring surfaces 22 and 32 have been formed in a direction perpendicular to these axes, thus maintaining alignment of the tip surfaces in a horizontal plane as shown in the drawings.

Consequently, in order to constrain the axial inclination of the upper and lower mold elements 20 and 30 as much as possible at the time of heating and pressuring the optical material 90, it is necessary to secure the processing accuracy of the four constraint surfaces (contact surfaces). Here, the processing accuracy of the flange surfaces 28 and 38 of the upper and lower mold elements 20 and 30 is even more important than that of the pressuring surfaces 72 and 82 of the pressuring plates 70 and 80. In addition, because the constraint surfaces (contact surfaces) are formed to define a certain separation distance between the shafts of the upper and lower molds 20 and 30, even when the pressuring surfaces 72 and 82 of the upper and lower pressuring plates 70 and 80 have less flatness related to errors of unevenness and/or inclination, they have an advantage of also helping to reduce the inclination of the shafts of the upper and lower mold elements 20 and 30 caused by errors in sizing of components due to manufacturing tolerances.

The optical element molding device of Embodiment 1 is as described above. In this optical element molding device 10, the upper and lower mold elements 20 and 30 have the outer surfaces of their shafts 24 and 34, respectively, inserted in the first cavity mold element 40, and the flange surfaces 28 and 38 extend perpendicular to these outer surfaces and are parallel to the end surface 52 of the second cavity mold element 50. The upper and lower mold elements 20 and 30 are guided and move up and down so as to have the outer surfaces of their shafts 24 and 34 sliding on the inner surface of the first cavity mold element 40, and the axial deviation is constrained. If the flange surface 28 of the upper mold element 20 comes into contact with the upper end surface 52 of the second cavity mold element 50 and the flange surface 38 of the lower mold element 30 comes into contact with the lower end surface 52 of the second cavity mold element 50, the pressuring limit distance and the axial inclination of the upper and lower mold elements 20 and 30 are constrained. With this design, when the upper end surface 52 of the second cavity mold element 50 comes into contact with the flange surface 28 of the upper mold element 20 and the lower end surface 52 comes into contact with the flange surface 38 of the lower mold element 30, the parallelism of the upper and lower mold elements 20 and 30 is secured, and the optical material 90 arranged between the upper and lower mold elements 20 and 30 is pressured in the state where the pressuring limit distance of the upper and lower mold elements 20 and 30 and the axial inclination is constrained, so that molding an optical element with high accuracy is assured.

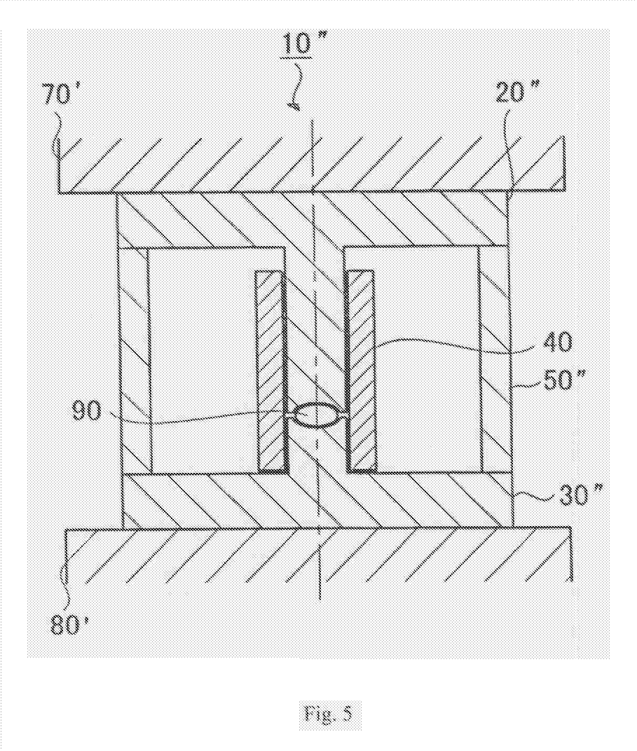

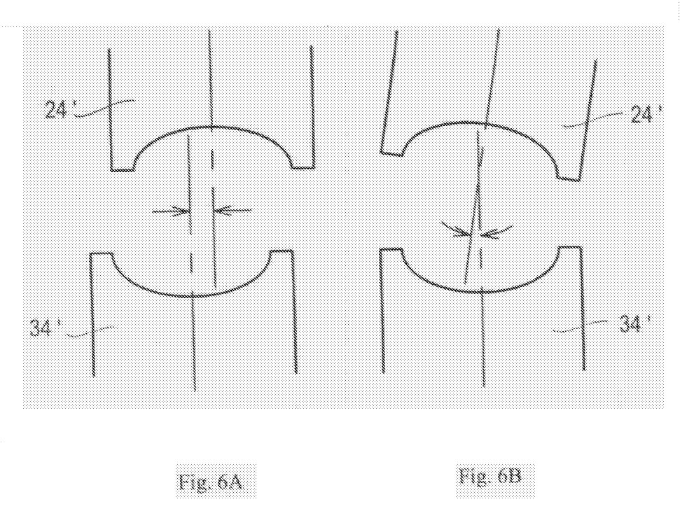

FIGS. 6A-6B show cross-sections of arrangements of mold elements with errors of axial alignment and axial inclination, respectively, that result in errors in the shape of the optical function surfaces of molded optical elements. As shown in FIG. 6A, the axis of the shaft 24′ of the upper mold element is parallel to but displaced in a horizontal direction from the axis of the shaft 34′ of the lower mold element. As shown in FIG. 6B, the axis of the shaft 24′ of the upper mold element is inclined from the axis of the shaft 34′ of the lower mold element. The optical element molding device of the present invention prevents both of these errors to a very high degree and thus ensures that the axes of the shafts 24 and 34 are aligned to essentially define a common axis in order to, in turn, ensure molding an optical element of a desired shape.

### Embodiment 2

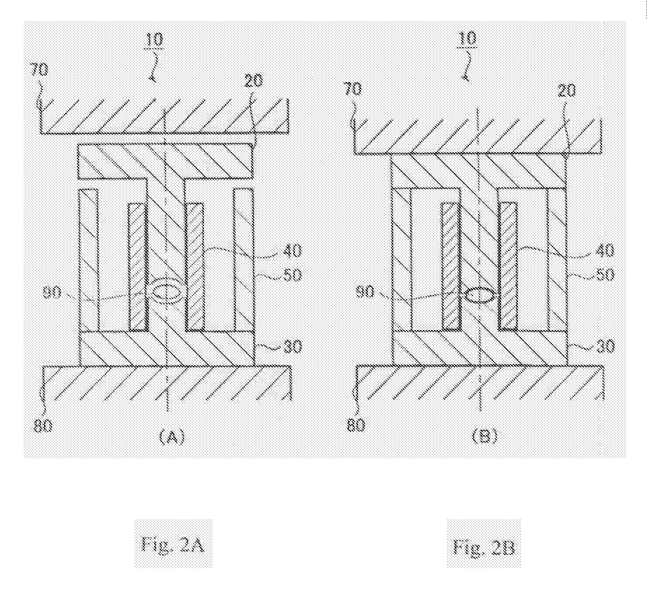

Next an optical element molding device related to a second embodiment, Embodiment 2, of the present invention is described. FIG. 3 shows a cross-sectional view of the optical element molding device of Embodiment 2 of the present invention. Embodiment 2 is similar to Embodiment 1, and therefore much of its operation may be understood from the previous discussion of Embodiment 1 and FIGS. 1, 2A, and 2B. In Embodiment 2, the same reference symbols as in Embodiment 1 are used for components that may be the same as in Embodiment 1, and components that are different but correspond to components of Embodiment 1 are referenced by the same reference symbol with a prime symbol added, as shown in FIG. 3. The optical element molding device 10′ of Embodiment 2 is different from Embodiment 1 in that the second cavity mold element 50′ comes into contact with only one of the upper mold element 20′ or the lower mold element 30. FIG. 3 illustrates the situation of the second cavity mold element 50′ coming into contact with only the lower mold element 30. In other words, the second cavity mold element 50′ is formed so as to have its axial length longer than that of the first cavity mold element 40 and longer than the sum of the axial lengths of the shafts 24 and 34 of the upper and lower mold elements 20′ and 30 plus the thickness of the pedestal of the upper mold element 20′.

Hereinafter, regarding heating and pressuring processes for the optical material 90 using the optical element molding device 10′ of Embodiment 2, the descriptions will be directed to pointing out the differences between Embodiments 1 and 2.

The upper and lower mold elements 20′ and 30 follow the upper and lower pressuring plates 70 and 80, which move up and down due to ascent and descent forces provided from pressuring mechanisms (not shown in the drawings). Here, the vertical movements of the upper and lower mold elements 20′ and 30 are guided by sliding within the first cavity mold element 40 with a friction fit so that axial deviation is restrained. In addition, in the upper and lower mold elements 20′ and 30, even when axial inclination occurs during pressing, the pressuring limit distance determined by the separation of the upper and lower mold elements 20′ and 30, which determines the central thickness of the optical element being molded, is reached and any axial inclination is constrained by having the second cavity mold element 50′ come into contact with the lower mold element 30 and the upper pressuring plate 70.

As described above, it is necessary to form the first cavity mold element 40 so as to have its axial length smaller than the sum of the axial lengths of the shafts 24 and 34 of the upper and lower mold elements 20′ and 30 and to form the second cavity mold element 50′ so as to have its axial length longer than that of the first cavity mold element 40 and greater than the sum of the axial lengths of the shafts 24 and 34 of the upper and lower mold elements 20′ and 30 plus the thickness of the pedestal of the upper mold 20′. With this design, the first cavity mold element 40 will not simultaneously come into contact with the upper and lower mold elements 20′ and 30, and the end surface of the shaft 24 of the upper mold element 20′ will never come into contact with the end surface of the shaft 34 of the lower mold element 30, but rather the second cavity mold element 50′ comes into contact with the lower mold element 30 and the upper pressuring plate 70.

In other words, when the second cavity mold element 50′ comes into contact with the lower mold element 30 and the upper pressuring plate 70, the lower end surface 52 of the second cavity mold element 50′ comes into contact with the flange surface of the lower mold element 30 and the upper end surface 52 of the second cavity mold element 50′ comes into contact with the pressuring surface 72 of the upper pressuring plate 70. As described above, the upper and lower end surfaces of the second cavity mold element 50′ are formed as surfaces that are perpendicular to the axis of the second cavity mold element 50′ and the flange surface of the lower mold element 30 is formed as a surface that is perpendicular to the axis of the lower mold element 30. Therefore, when the upper and lower end surfaces 52, 52 of the second cavity mold element 50′ make contact with the flange surface 38 of the lower mold element 30 and the pressuring surface 72 of the upper pressuring plate 70, these surfaces function as restraint surfaces to maintain a separation between both of the tip surfaces of the shafts 24 and 34 where the optical function transferring surfaces 22 and 32 have been formed on the upper and lower mold elements 20′ and 30.

Consequently, in order to constrain as much as possible the axial inclination of the upper and lower mold elements 20′ and 30 at the time of heating and pressuring the optical material 90, it becomes necessary to secure the molding accuracy on the four constraint surfaces similarly to Embodiment 1. However, the molding device 10′ of Embodiment 2 has the advantage of easily securing the accuracy of the constraint surfaces by having the one end surface 52 of the second cavity mold element 50′ come into contact with either the flange surface of the upper mold element 20′ or the flange surface of the lower mold element 30. In this case, the processing accuracy of these flange surfaces of the upper and lower mold elements 20′ and 30 is even more important than that of the pressuring surfaces 72 and 82 of the pressuring plates 70 and 80.

As described above, the optical element molding device 10′ of Embodiment 2 includes upper and lower mold elements 20′ and 30 that have shafts 24 and 34 with outer surfaces that are inserted in the first cavity mold element 40 and flange surfaces that extend perpendicular to these outer surfaces and are parallel to the end surfaces 52, 52 of the second cavity mold element 50′. When the upper and lower mold elements 20′ and 30 are guided and move up and down so as to have the outer surfaces of their shafts 24 and 34 sliding on the inner surface of the first cavity mold element 40, axial deviation is constrained. Additionally, the pressuring limit distances and the axial inclination of the upper and lower molds 20′ and 30 are constrained by having the flange surface 28 of the upper mold element 20′ come into contact with the upper end surface 52 of the second cavity mold element 50′ or having the flange surface 38 of the lower mold element 30 come into contact with the lower end surface 52 of the second cavity mold element 50′. With this design, the parallelism of the upper and lower molds 20′ and 30 is secured by having one end surface 52 of the second cavity mold element 50′ come into contact with the flange surface of the upper mold element 20′ or the lower mold element 30, and the optical material 90 arranged between the upper and lower mold elements 20′ and 30 is pressured in the state where the pressuring limit distances and the axial inclination of the upper and lower mold elements 20′ and 30 are restrained, and an optical element with high accuracy can be molded.

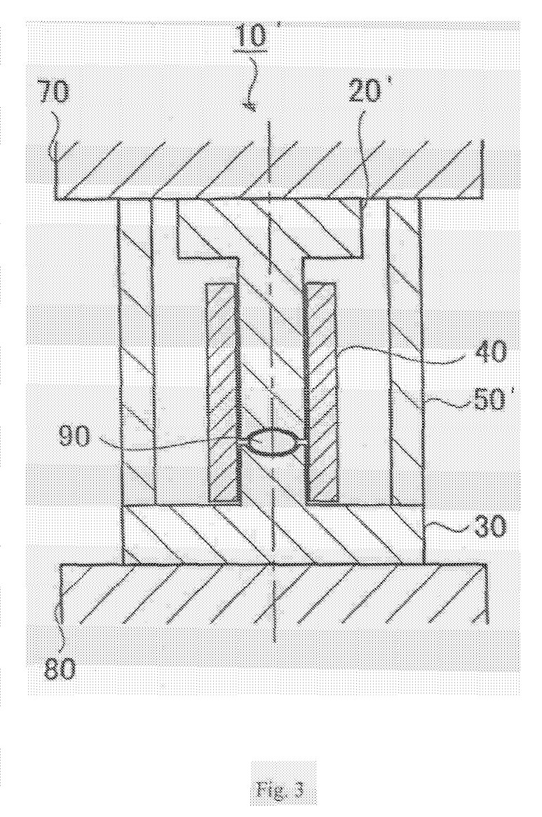

The situation where the second cavity mold element 50′ comes into contact with the lower mold element 30 and the upper pressuring plate 70 has been described above. However, instead, as shown in FIG. 4, in a variation of Embodiment 2, the present invention accomplishes a similar effect in the case where the second cavity mold element 50′ comes into contact with the upper mold element 20 and the lower pressuring plate 80. In this case, it is necessary to form the second cavity mold element 50′ so as to have its axial length longer than that of the first cavity mold element 40, and longer than the sum of the axial lengths of the shafts 24 and 34 of the upper and lower mold elements 20 and 30′ plus the thickness of the pedestal of the lower mold element 30′.

### Embodiment 3

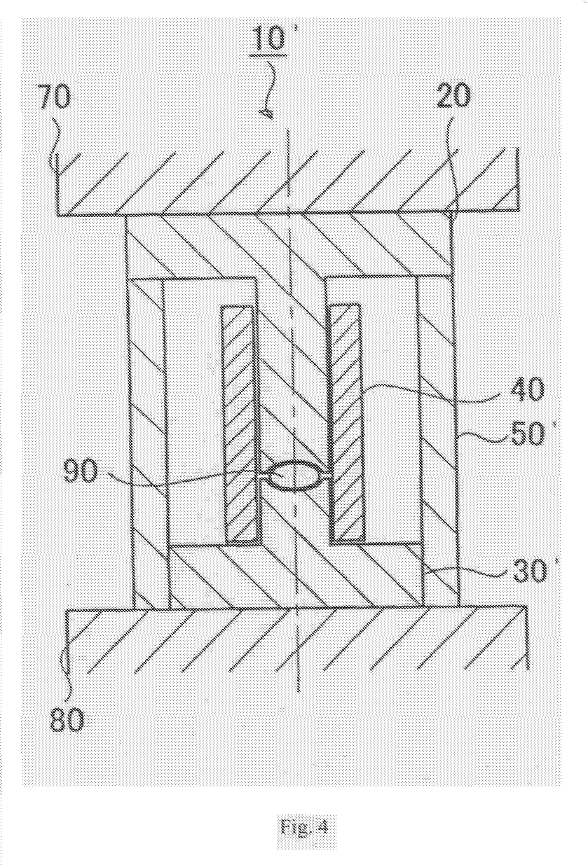

Next, an optical element molding device related to a third embodiment, Embodiment 3, of the present invention is described. FIG. 5 shows a cross-sectional view of the optical element molding device of Embodiment 3 of the present invention. Embodiment 3 is similar to Embodiment 1, and therefore much of its operation may be understood from the previous discussion of Embodiment 1 and FIGS. 1, 2A, and 2B. In Embodiment 3, the same reference symbols as in Embodiment 1 are used for components that may be the same as in Embodiment 1 and components that are different but correspond to components of Embodiment 1 are referenced by the same reference symbol with a prime symbol added, unless the components have been previously referenced with a prime symbol with regard to Embodiment 2, in which case the same reference symbol with two prime symbols added are used for Embodiment 3. As shown in FIG. 5, the optical element molding device 10″ of Embodiment 3 is different from Embodiments 1 and 2 in the longer extension of the pedestals of the upper mold element 20″ and/or the lower mold element 30″ (FIG. 5 shows an arrangement where both upper and lower mold elements 20″ and 30″ have longer extensions) and a corresponding longer extension of the second cavity mold element 50″ and the pressuring plates 70′ and 80′ as shown in FIG. 5.

Hereinafter, regarding heating and pressuring processes for the optical material 90 using the optical element molding device 10″ of Embodiment 3, the descriptions will be directed to pointing out the differences of Embodiment 3 from Embodiments 1 and 2.

The upper and lower mold elements 20″ and 30″ follow the upper and lower pressuring plates 70′ and 80′, which move up and down due to ascent and descent forces provided from pressuring mechanisms (not shown in the drawings). Here, the vertical movements of the upper and lower mold elements 20″ and 30″ are guided by sliding within a friction fit of their outer surfaces against the inner surface of the first cavity mold element 40 so that axial deviation is restrained. In addition, in the upper and lower mold elements 20″ and 30″, even when axial inclination occurs during pressing, the pressuring limit distances determined by the separation of the upper and lower mold elements 20″ and 30″, which determines the central thickness of the optical element being molded, is reached and any axial inclination is constrained by having the second cavity mold element 50″ come into contact with the upper mold element 20″ and the lower mold element 30″.

Consequently, in order to constrain the axial inclination of the upper and lower mold elements 20″ and 30″ as much as possible at the time of heating and pressuring the optical material 90, it becomes necessary to ensure the processing accuracy on the four constraint surfaces, similar to Embodiments 1 and 2. However, in the optical element molding device 10″ of Embodiment 3, in addition to the advantages obtainable in Embodiments 1 and 2 described above, because the restraint surfaces (contact surfaces) are formed to extend to a relatively longer distance from the axes of the upper and lower mold elements, even when the pressuring surfaces of the upper and lower plates 70′ and 80′ have less flatness due, for example, to manufacturing errors, there also exists the advantage of the axial inclination of the upper and lower mold elements 20″ and 30″ caused by such errors being smaller than would exist in Embodiments 1 and 2.

The optical element molding device of Embodiment 3 is as described above. In this optical element molding device 10″, if the contact surface of the flange surface of the upper mold element 20″ and/or the contact surface of the flange surface of the lower mold element 30″ are/is formed at a predetermined distance from the axes of the upper and lower mold elements 20″ and 30″, the pressing limit distances and the axial inclination of the upper and lower mold elements 20″ and 30″ are constrained. With this design, the formation of the contact surfaces of the flange surface of the upper mold element 20″ with the second cavity mold element 50″ and/or the contact surface of the flange surface of the lower mold element 30″ with the second cavity mold element 50″ at the predetermined distance results in further improvement in the parallelism of the upper and lower mold elements 20″ and 30″, the optical material 90 arranged between the upper and lower molds 20″ and 30″ is pressured in a state where the pressuring limit distances and the axial inclination in the upper and lower mold elements 20″ and 30″ are constrained, and an optical element with higher accuracy can be molded.

Preferred embodiments of the present invention have been described above with reference to the attached drawings. However, it is obvious that the present invention is not limited to these embodiments and may be varied in many ways with such variations falling within the scope of the present invention.

For example, in embodiments described above, the case where the upper mold element (20, 20′, 20″) is movable relative to the first cavity mold element 40 and the second cavity mold element (50, 50′, 50″) has been described. However, the present invention is not limited to these embodiments, and the present invention may be similarly realized in the case where the lower mold element (30, 30′, 30″) is movable relative to the upper mold element (20, 20′, 20″), the first cavity mold element 40, and the second cavity mold element (50, 50′, 50″), or in a different case wherein both the upper and lower mold elements (20, 20′, 20″ and 30, 30′, 30″) are movable relative to the first cavity mold element 40 and the second cavity mold element (50, 50′, 50″).

Moreover, for example, the present invention is not limited to the case wherein the entire end surface of the second cavity mold element (50, 50′, 50″) is formed as surfaces that are perpendicular to the axis of the second cavity mold element (50, 50′, 50″), but the present invention may be similarly realized in obtaining parallelism of the upper and lower mold elements (20, 20′, 20″ and 30, 30′, 30″) wherein only portions of these surfaces that are formed for contact are formed as surfaces perpendicular to the axis and portions that are not contacting surfaces are not required to satisfy this perpendicular relationship. Moreover, this is similarly true of the flange surfaces of the upper and lower mold elements (20, 20′, 20″ and 30, 30′, 30″).

Additionally, for example, the present invention is not limited to the case wherein the second cavity mold element (50, 50′, 50″) has the upper and lower end surfaces perpendicular to its axis, and the present invention may be similarly realized wherein the upper and lower end surfaces are formed so as to be engaged with the contact surfaces of the upper and lower mold elements (20, 20′, 20″ and 30, 30′, 30″) or where the contact surfaces of the upper and lower pressuring surfaces have, for example, convex and concave shapes with one surface inclined toward the inside of the corresponding cavity mold element and another surface inclined toward the outside of the corresponding cavity mold element.

Moreover, for example, although in the embodiments described above, the second cavity mold element (50, 50′, 50″) has at least generally the shape of a right circular cylinder, the present invention is not limited to this arrangement, and the formation of the contact surfaces with the upper and lower mold elements (20, 20′, 20″ and 30, 30′, 30″) or contact surfaces with the upper and lower pressuring plates (70, 70′ and 80, 80′) may be similarly applied with other shapes, for example, to structures formed as multiple columnar members as long as the parallelism of the upper and lower mold elements (20, 20′, 20″ and 30, 30′, 30″) can be realized.

Such variations as described above are not to be regarded as a departure from the spirit and scope of the invention. Rather, the scope of the invention shall be defined as set forth in the following claim and its legal equivalents. All such modifications as would be obvious to one skilled in the art are intended to be included within the scope of the following claim.

What is claimed is:

1. An optical element molding device comprising:
an upper mold element;
a lower mold element;
a first cavity mold element; and
a second cavity mold element that includes an upper end surface and a lower end surface; wherein
each of said upper mold element and said lower mold element includes a pedestal and a shaft projecting from each pedestal;
the shafts of the pedestals extend along a common axis;
an optical function transferring surface is formed at the tip of each shaft with the tips facing one another along said common axis;
said first cavity mold element extends around said tips and said common axis for molding an optical element by heating and pressuring an optical material arranged between said upper mold element and said lower mold element by said upper mold element and said lower mold element moving relatively toward one another along said common axis guided by said first cavity mold element;
each of the pedestals includes a flange surface extending away from said common axis;
said second cavity mold element extends around said first cavity mold element but does not contact said first cavity mold element; and
at least one of said upper end surface and said lower end surface contacts one of the flange surfaces in order to limit relative movement of said upper mold element and said lower mold element toward one another during molding of an optical element and at the same time constrain axial inclination of said upper mold element and said lower mold element about said common axis.
